(19) United States
(12) Patent Application Publication
(10) Pub. No.: US 2013/0241409 A1
(43) Pub. Date: Sep. 19, 2013

(54) NON AXIS SYMMETRIC SPARK PLUG WITH OFFSET BORE

(71) Applicant: FRAM GROUP IP LLC, Lake Forest, IL (US)

(72) Inventor: Matthew B. Below, Findlay, OH (US)

(73) Assignee: FRAM GROUP IP LLC, Lake Forest, IL (US)

(21) Appl. No.: 13/787,051

(22) Filed: Mar. 6, 2013

Related U.S. Application Data
(60) Provisional application No. 61/611,874, filed on Mar. 16, 2012.

(51) Int. Cl. H01T 13/20

(52) U.S. Cl. CPC H01T 13/20
USPC 315/58; 313/143

(57) ABSTRACT

A spark plug is provided including an outer shell and an insulator having a bore extending therethrough, the bore having a first bore section and a second bore section. The first bore section and the outer shell extend along a common longitudinal axis. The second bore section extends along a second longitudinal axis offset from the common longitudinal axis. The spark plug further includes a center electrode and a ground electrode.

### CROSS-REFERENCE

This application claims the benefit of U.S. Provisional Patent Application No. 61/611,874, filed Mar. 16, 2012 and entitled “Small Diameter Non Axis Symmetric Spark Plug with Offset Bore,” the entire disclosure of which is incorporated herein.

### BACKGROUND

This application relates generally to spark plugs for internal combustion engines, and more particularly, to the construction of a small diameter spark plug. More particularly, the present description relates to a small diameter spark plug having increased dielectric strength.

Conventional spark plugs for internal combustion engines generally include a threaded outer metal shell and an insulator disposed within the outer shell, the insulator formed to include a bore in which an electrode is arranged. The bore is traditionally aligned with the center axis of the spark plug. The bore may extend through the entire length of the insulator and be aligned symmetrically down the middle of the insulator and the outer shell. In this way, the insulator and outer shell are symmetrical about the electrode extending through the bore of the insulator, and the electrode extends through the insulator along the center axis of the spark plug. When installed in the internal combustion engine, conventional spark plugs are configured to have a standard outer diameter configured to fit inside a customary threaded hole provided in an engine head to protrude into a combustion chamber.

The insulator of the spark plug may be measured by its dielectric strength. The dielectric strength of a material refers to the maximum electrical potential that a material can withstand without failure. For example, in the field of electrical insulators, the dielectric strength of the insulator refers to the amount of electrical potential the insulator can withstand without experiencing failure of its insulation properties. Among the factors that may affect the dielectric strength of the material is the thickness of the material. For example, an increase in the thickness of the insulation material may lead to a higher dielectric strength.

A small diameter spark plug may include a threaded outer shell used for installation in a standard threaded hole in the engine head. Because of the mechanical strength necessary to support the mechanical threads on the outer shell, the outer shell wall must be thicker adjacent the threads. However, because such a spark plug must be useable in standard or conventional threaded holes of an engine head, the outer diameter of the spark plug must remain constant. Thus, use of thicker material for the outer shell wall translates into reduction in the amount and thickness of the insulator of the small diameter spark plug. The limited thickness of the insulator may reduce the potential dielectric strength of the insulator. A result of this design is that the spark plug includes a thin ceramic wall insulator that requires lower voltage ignition systems in order to reduce the likelihood of failure. In addition, the spark plug may require a smaller spark gap between the electrode and a ground electrode attached to the metal shell due to the lower voltage requirement.

Accordingly, while existing spark plug systems are suitable for their intended purpose, the need for improvement remains and it may be desirable to provide a small diameter spark plug in which the thickness of the insulator is maintained or increased in order to maintain or increase the dielectric strength of the insulator, while maintaining the size of the outer diameter of the spark plug in order to be compatible with standard ignition systems.

### SUMMARY

According one exemplary embodiment, there is provided a spark plug including an outer shell defining a first longitudinal axis. The spark plug also includes an insulator having a first opening at a first end thereof and a second opening at a second end thereof, at least a portion of the insulator extending within the outer shell. An insulator bore extends between the first opening and second opening of the insulator, and includes a first bore section extending along first longitudinal axis, a second bore section extending along a second longitudinal axis. The second longitudinal axis is offset from the first longitudinal axis. A stepped bore section is positioned between the first bore section and second bore section. The spark plug also includes a terminal stud at least partially disposed in the first bore section, a center electrode positioned at least partially in the second bore section, and a ground electrode extending with the insulator and terminating at a position axially beyond the second end of the insulator.

In another exemplary embodiment, there is provided an insulator for a spark plug, the insulator including a first end having a first opening, a second end having a second opening, and a bore extending from the first opening to the second opening. The bore includes a first section extending along a first longitudinal axis and configured to receive a terminal stud and a second section extending along a second longitudinal axis and configured to receive a center electrode. The second longitudinal axis is offset from the first longitudinal axis.

In still another exemplary embodiment, there is provided a spark plug including an outer shell and an insulator having a bore extending therethrough, the bore having a first bore section and a second bore section. The first bore section and the outer shell extend along a common longitudinal axis and the second bore section extends along a second longitudinal axis offset from the common longitudinal axis. The spark plug further includes a center electrode and a ground electrode.

The above described and other features are exemplified by the following figures and detailed description.

### BRIEF DESCRIPTION OF DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a cross-sectional side view of a spark plug according to an exemplary embodiment of the present invention;

FIG. 2 is a side view of the spark plug of FIG. 1;

FIG. 3 is a front end view of the spark plug of FIG. 1;

FIG. 4 is a cross-sectional side view of a spark plug according to another exemplary embodiment of the present invention;

FIG. 5 is a side view of the spark plug of FIG. 4; and,

FIG. 6 is a front end view of the spark plug of FIG. 4.

### DETAILED DESCRIPTION

A spark plug 5 in accordance with exemplary embodiments of the present disclosure includes an outer metal shell 10, an insulator 20 at least partially surrounded by the outer shell 10, and a center electrode 40 surrounded by the insulator 20. The insulator 20 includes a bore 26 through which the center electrode 40, a terminal stud 30, and a resistor 60 are located. The center electrode 40 extends past the insulator 20, and a ground electrode 50 extends from the outer shell 10 adjacent to where the center electrode 40 extends past the insulator 20. A center longitudinal axis of the outer shell 10 is aligned along a first longitudinal axis A. The outer shell 10 is configured to include a threaded region 17 that enables at least the center electrode 40 and the ground electrode 50 of the spark plug 5 to be secured into an opening (not shown) in a combustion chamber of an engine (not shown). In illustrative embodiments, at least a portion of the bore 26 is not aligned with the first longitudinal axis A but instead is offset form the first longitudinal axis A along a second longitudinal axis B that may be parallel to the first longitudinal axis A. In other words, the portion of the bore that is not aligned with the first longitudinal axis A is not symmetrical about the longitudinal axis of the outer shell 10, but instead, is symmetrical about the second longitudinal axis B. The offset of the portion of the bore 26 enables the insulator 20 to be formed of the same or increased amount of insulation material along the metal shell 10, especially within the region where the ground electrode 50 is coupled to the metal shell 10, thereby maintaining or increasing the dielectric strength of the insulator 20.

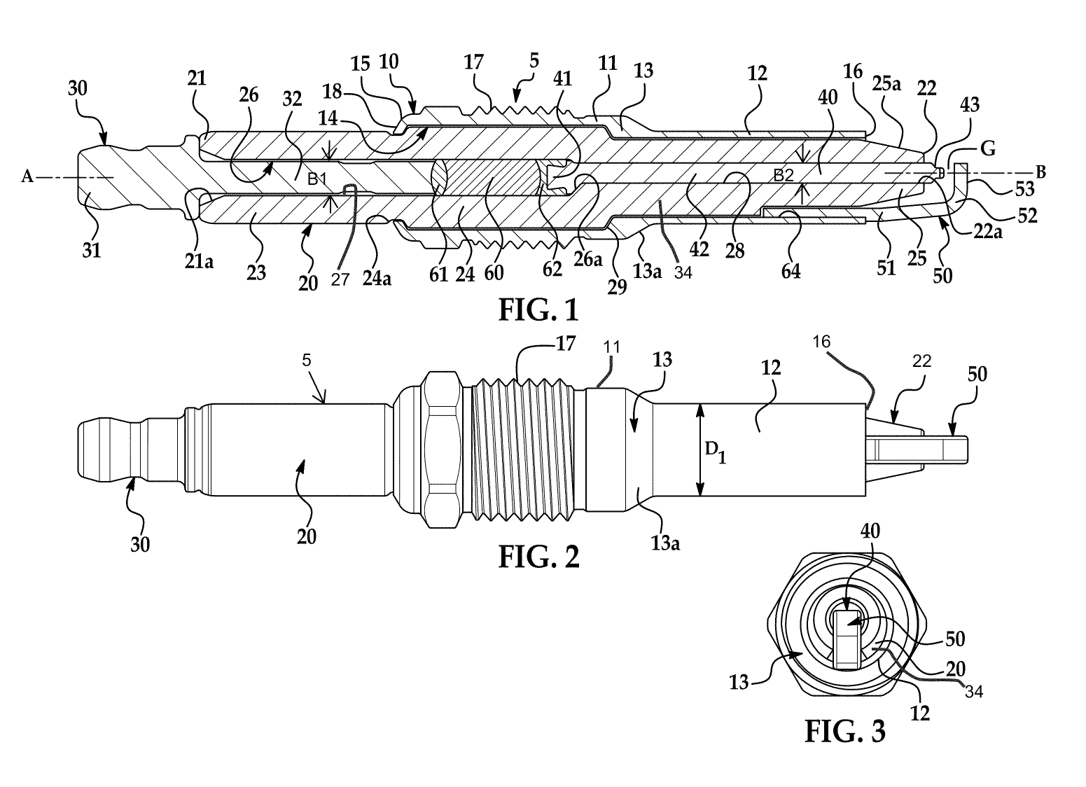

As illustrated in FIG. 1, the outer shell 10 of the spark plug 5 includes a first end 15 and a second end 16 opposite the first end 15. A first-diameter portion 11 is adjacent the first end 15, a second-diameter portion 12 is adjacent the second end 16, and a stepped-diameter portion 13 is positioned between the first-diameter portion 11 and the second-diameter portion 12. The outer shell 10 defines the first longitudinal axis A along which the length of the outer shell 10 extends. A bore 14 extends through the length of the outer shell 10 from the first end 15 to the second end 16 and is also aligned along the first longitudinal axis A. The outer shell 10 may be manufactured using suitable processes. For example, the outer shell 10 may be machined or headed.

The first-diameter portion 11 includes the threaded region 17 extending radially outward from an outer surface of the outer shell 10. The threaded region 17 may be used to threadably engage a corresponding threaded hole in an engine (not shown), thereby securably fixing the spark plug 5 to the engine. In an exemplary embodiment, the threaded region 17 is disposed toward a central region of the spark plug 5, away from longitudinal ends of the spark plug 5. The first-diameter portion 11 also includes an inner diameter defined by the bore 14 and a protrusion 18 extending radially inward, i.e., toward the first longitudinal axis A, as illustrated in FIG. 1.

The second-diameter portion 12 of the outer shell 10 includes an inner diameter also defined by the bore 14 and an outer diameter D 1. In an exemplary embodiment, the outer diameter D1 may be in the range of 7.5 mm-10 mm, but is not limited thereto. In an illustrative embodiment, the inner and outer diameters of the second-diameter portion 12 may be less than the inner and outer diameters of the first-diameter portion 11.

The stepped-diameter portion 13 is positioned between the first-diameter portion 11 and the second-diameter portion 12 along the length of the outer shell 10. The stepped-diameter portion 13 includes an inner diameter of varying size along at least part of a length of the stepped-diameter portion 13. The stepped-diameter portion 13 also includes an outer diameter of varying size along at least part of the length of the stepped-diameter portion 13. As illustrated in FIG. 2, the outer surface of the stepped-diameter portion 13 is configured to form a seat 13a of the spark plug 5 when the spark plug 5 is engaged in an threaded hole of the engine (not shown).

It should be understood that the first-diameter portion 11, the second-diameter portion 12, and the stepped-diameter portion 13 of the outer shell 10 are referenced for the purpose of assisting in the identification of various features in the exemplary embodiments of the present invention. The relative dimensions of the portions and their respective positions relative to the other features of the exemplary embodiments are not limited to the configurations shown in the illustrated exemplary embodiments.

The insulator 20 of the spark plug 5 includes a first end 21 and a second end 22 opposite the first end 21. When the insulator 20 is located in the bore 14 of the outer shell 10, the first end 21 and the second end 22 extend past the first end 15 and the second end 16 of the outer shell 10, respectively. The insulator 20 further includes at least one groove 24a formed along an outer periphery thereof. The at least one groove 24a is configured to receive the protrusion 18 of the outer shell 10 when the insulator 20 is secured in the bore 14 of the outer shell 10.

The insulator 20 includes a first section 23, a second section 24, and a third section 25. In an exemplary embodiment, the first section 23 of the insulator 20 represents an outer surface of the spark plug 5 and extends from the first end 21 of the insulator 20 to a point where the insulator 20 is adjacent the first end 15 of the outer shell 10. The second section 24 of the insulator 20 extends away from the first section 23 to a point where the insulator 20 is adjacent the second end 16 of the outer shell 10. An outer diameter of the insulator 20 along the second section 24 generally corresponds to the respective inner diameters of the first-diameter portion 11, second-diameter portion 12 and stepped-diameter portion 13 of the outer shell 10, so that the second section 24 of the insulator 20 may be tightly received in the outer shell 10. That is, the outer diameter of the insulator 20 along the second section 24 is generally tightly received in the bore 14 of the outer shell 10.

In illustrative embodiments, and as seen in FIG. 1, a gap or opening 64 may be formed between the second section 24 and the outer shell 10 adjacent the second end 16 of the outer shell 10. The second section 24 of the insulator 20 adjacent the opening 64 is reduced in diameter to form the opening 64 while maintaining the outer diameter of the second end 16 of the outer shell 10 at a constant diameter. The reduction in diameter of the insulator 20 means that the insulation material may be reduced along that portion of the insulator 20. The opening 64 is configured to receive a portion of the ground electrode 50, as further discussed below.

The third section 25 of the insulator 20 extends axially beyond the second end 16 of the outer shell 10 to the second end 22 of the insulator 20. The third section 25 includes a tapered portion 25a where an outer diameter of the third section 25 is reduced. The outer diameter of the third section 25 generally represents an outer surface of the spark plug 5.

It should be understood that the first section 23, the second section 24, and the third section 25 of the insulator 20 are referenced for the purpose of assisting in the identification of various features in the exemplary embodiments of the present invention. The relative dimensions of the sections and their respective positions relative to the other features of the exemplary embodiments are not limited to the configurations shown in the illustrated exemplary embodiments.

The first end 21 of the insulator 20 is formed to include a first opening 21a, and the second end 22 of the insulator 20 is formed to include a second opening 22a. A bore 26 extends through the insulator 20 from the first opening 21a to the second opening 22a. The bore 26 includes a first-bore section 27, a stepped-bore section 26a, and a second-bore section 28. The second-bore section 28 is located opposite of the first-bore section 27, and the stepped-bore section 26a is located between the second-bore section 28 and the first-bore section 27. The first-bore section 27, the second-bore section 28, and the stepped-bore section 26a are configured to receive the terminal stud 30 or the center electrode 40, or both, as further discussed below.

The first-bore section 27 may be defined between the first opening 21a of the insulator 20 and the stepped-bore section 26a within the bore 26. The first-bore section 27 extends generally coaxially with the first section 23 of the insulator 20 and the outer shell 10. That is, the first-bore section 27 has a common longitudinal axis, the first longitudinal axis A, with the outer shell 10 and the first section 23 of the insulator 20. The first-bore section 27 may also be symmetrical about the first longitudinal axis A. The first-bore section 27 may have a first bore diameter B1.

The second-bore section 28 may be defined between the stepped-bore section 26a of the bore 26 and the second opening 22a of the insulator. The second-bore section 28 has a diameter that is less than the diameter of the first-bore section 27 and extends along a second longitudinal axis B that is offset from first longitudinal axis A. The second-bore section 28 is therefore not symmetrical about the first longitudinal axis A. The second-bore section 28 may have a second bore diameter B2. In illustrative embodiments, the second bore diameter B2 is less than the first bore diameter B1.

As the second-diameter portion 12 of the outer shell 10 near the second-bore section 28 is maintained at a constant diameter B2 and the insulator 20 generally fits tightly against the outer shell 10, the offset or shifted second longitudinal axis B ensures there is additional insulator material between the second-bore section 28 and a portion of the outer shell 10 and/or the ground electrode 50. This insulator material traditionally would have been reduced due to the opening 64 for the ground electrode 50 in standard spark plugs. Accordingly, the insulator 20, in the region of the second-bore section 28, has an increased wall thickness along an axial side 34 of the spark plug 5. Specifically, side 34 is located along the same side as opening 64 or ground electrode 50. Thus, in the region of the second-bore section 28, the wall thickness of the insulator 20 varies such that an increased wall thickness is provided along the side 34 that is opposite from which the second-bore section 28 is offset. Here, the term “increased” is used to describe the thickness of the material of the insulator 20 relative to a scenario where the first-bore section 27 and the second-bore section 28 extend coaxially with one another along the same first longitudinal axis A, as in standard spark plugs.

The increased thickness in the insulator 20, which results from the features detailed above, increases the dielectric strength of the insulator 20. As a result, the spark plug may handle a larger potential difference without failing, and thus, may be used in standard ignition systems using a higher voltage and including a standard spark gap G.

The insulator 20 may be formed of any suitable insulating material used in spark plugs. For example, the insulator 20 may be formed of a ceramic material. The insulator 20 may be manufactured using several suitable processes. For example, the insulator 20 may be made by injection molding or using an isostatic press and grind process.

In exemplary embodiments, the terminal stud 30 is inserted into the bore 26 of the insulator 20 and includes a head 31 and body 32. The head 31 of the terminal stud 30 extends outwardly from the first section 23 of the insulator 20, past the first opening 21a of the bore 26. The body 32 extends within the first section 23 of the insulator 20 in the first-bore section 27. In an exemplary embodiment, the body 32 terminates in the first-bore section 27, as illustrated in FIG. 1. The terminal study 30 may generally be aligned with the first longitudinal axis A

The center electrode 40 also extends within the bore 26 of the insulator 20. In an exemplary embodiment, the center electrode 40 includes a skirt 41 and a body 42. The skirt 41 of the center electrode 40 may be positioned in the first-bore section 27 and the stepped-bore section 26a. The skirt 41 may be offset from the second longitudinal axis B and may generally be aligned with the first longitudinal axis A. In illustrative embodiments, the body 42 of the center electrode 40 extends through the second-bore section 28 of the bore 26. A head section 43 of the body 42 extends axially beyond the second end 22 of the insulator 20 through the second opening 22a of the bore 26.

The ground electrode 50 extends along a portion of the length of the outer shell 10 and insulator 20 and projects beyond the insulator 20 and center electrode 40. The ground electrode 50 may be at least partially received in a slot of the insulator 20, as illustrated in FIG. 1. The ground electrode 50 includes a first segment 51, a second segment 52, and a third segment 53. The ground electrode 50 may be formed in a specialized press or other suitable manufacturing process.

The first segment 51 of the ground electrode 50 extends generally along a portion of the length of the outer shell 10 and insulator 20, as illustrated in FIG. 1. At least a portion of the first segment 51 may be positioned between the outer shell 10 and insulator 20 in the opening 64 to secure the ground electrode 50 to the outer shell 10. The second segment 52 of the ground electrode 50 is positioned at one end of the first segment 51 and may form a curved portion of the ground electrode 50. The third segment 53 of the ground electrode 50 is positioned at one end of the second segment 52 and extends in a direction generally perpendicular to at least a portion of the first segment 51 and the second longitudinal axis B. The third segment 53 extends across the first and second longitudinal axes A and B. The third segment 53 is spaced from the head section 43 of the center electrode 40, thereby providing a spark gap G between the third segment 53 of the ground electrode 50 and the center electrode 40.

A resistor 60 may be positioned in the bore 26 of the insulator 20 between the terminal stud 30 and the center electrode 40. In an exemplary embodiment, the resistor 60 may be positioned in the first-bore section 27 and provides an electrical communication between the terminal stud 30 and the center electrode 40. In exemplary embodiments, a first contact glass portion 61 and a second contact glass portion 62 are disposed adjacent to respective ends of the resistor 60. The first contact glass portion 61 is disposed between the terminal stud 30 and the resistor 60. The second contact glass portion 62 is disposed between the resistor 60 and the second contact glass portion 62.

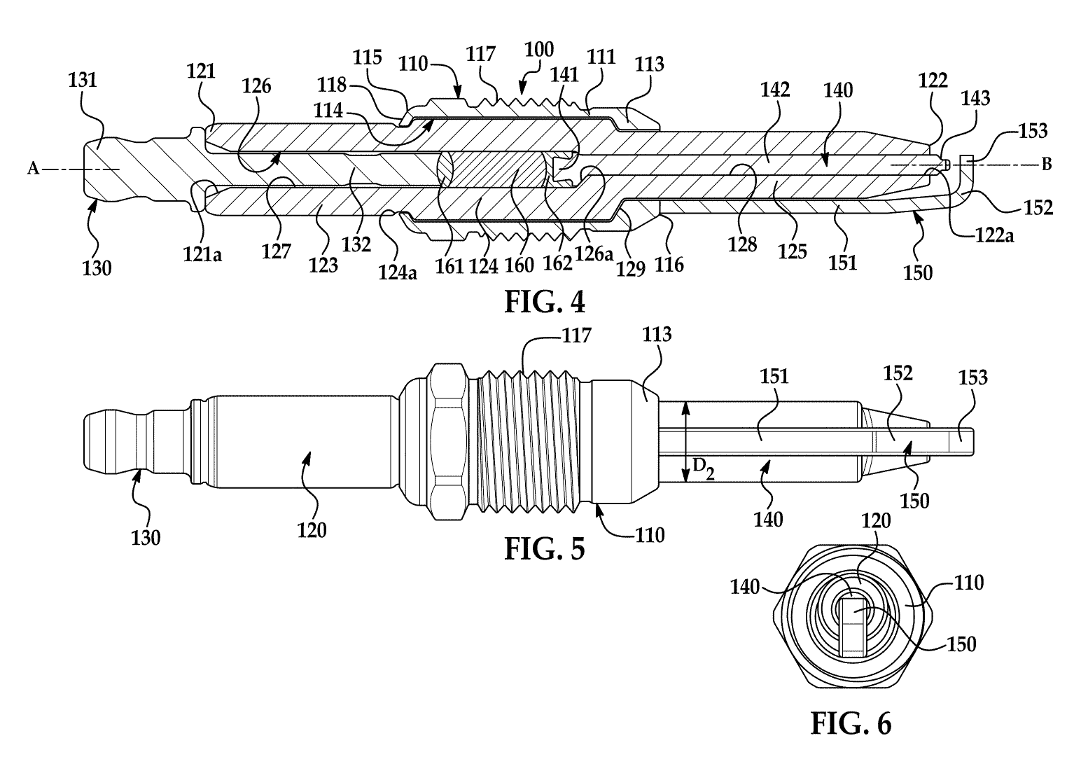

With reference to FIGS. 4-6, another exemplary embodiment of the present invention is provided. The spark plug 100 of this embodiment includes an outer shell 110, an insulator 120, a terminal stud 130, a center electrode 140, a ground electrode 150 and a resistor 160. Unless otherwise described below, these parts generally correspond to the similar parts described in the exemplary embodiments above.

The outer shell 110 of spark plug 100 includes a first end 115 and second end 116. In the spark plug 100 of this exemplary embodiment, the outer shell 110 is configured somewhat differently than described above with reference to FIGS. 1-3. Here, the outer shell 110 does not include a second diameter portion which corresponds to the second-diameter portion 12 described above. Rather, the outer shell 110 only comprises a first-diameter portion 111 adjacent the first end 115 and a stepped-diameter portion 113 adjacent the second end 116 of the outer shell 110. The first-diameter portion 111 includes a threaded portion 117 formed on an outer periphery thereof and extending radially outward from the outer shell 110. An inwardly projecting protrusion 118 is formed at the first end 115 of the outer shell 110. The outer shell 110 extends along a first longitudinal axis A. A bore 114 extends through the length of the outer shell 110 from the first end 115 to the second end 116 and is also aligned along a first longitudinal axis A.

The insulator 120 of spark plug 100 includes a first end 121 and a second end 122 opposite the first end 121. The first end 121 has a first opening 121a and the second end 122 has a second opening 122a. When the insulator 120 is located in the bore 114 of the outer shell 110, the first end 121 and the second end 122 extend past the first end 115 and the second end 16 of the outer shell 110, respectively. The insulator 120 further includes at least one groove 124a formed along an outer periphery thereof. The at least one groove 124a is configured to receive the protrusion 118 of the outer shell 110.

The insulator 120 also includes a first section 123, a second section 124, and a third section 125. The first section 123 extends from the first end 121 of the insulator 120 to a point on the insulator 120 adjacent the first end 115 of the outer shell 110, and generally represents an outer surface of the spark plug 100 in this region. The second section 124 extends from adjacent the first end 115 of the outer shell 110 to adjacent the second end 116 of the outer shell 110. The second section 124 is disposed radially within the outer shell 110 and is generally tightly received in the bore 114 of the outer shell 110. The third section 125 extends from the second end 116 of the outer shell 110 to the second end 122 of the insulator 120. The outer diameter of the third section 125 generally represents an outer surface of the spark plug 100. The third section 125 includes an outer diameter D2. In an exemplary embodiment, the outer diameter D2 may be in the range of 7.5 mm-10 mm, but is not limited thereto.

The insulator 120 includes a bore 126 extending from the first opening 121a to the second opening 122a of the insulator 120. The bore 126 includes a first-bore section 127, a second-bore section 128, and a stepped-bore section 126a. The first-bore section 127 extends coaxially with the outer shell 110 along the first longitudinal axis A. The second-bore section 128 has a smaller inner diameter and outer diameter than the first-bore section 127. In addition, the second-bore section 128 extends along a second longitudinal axis B. The second longitudinal axis B is offset from the first longitudinal axis A. In other words, the second-bore section 128 is symmetrical about the second longitudinal axis B, but not the first longitudinal axis A. The stepped-bore section 126a is positioned between the first-bore section 127 and the second-bore section 128 and has a diameter which varies along the length of the stepped-bore section 126a to taper from the first-bore section 127 to the second-bore section 128.

The offset longitudinal axes A and B allow for a portion of the insulator 120 to be of increased thickness, and thus, increased dielectric strength. In addition, by not including an outer shell extending over the third section 125 of the insulator 120, the diameter of the insulator may be increased to generally correspond to the diameter of a bore in an engine in which the spark plug 100 is to be installed, thereby further increasing the dielectric strength of the insulator 120.

The terminal stud 130 is received in the bore 126 along the first opening 121a. In the exemplary embodiment shown in FIG. 4, the terminal stud 130 includes a head portion 131 which extends outwardly from the first end 121 of the insulator 120 outside of the first opening 121a. The terminal stud 130 also includes a body portion 132 which extends within the first-bore section 127 of the bore 126.

The center electrode 140 is received within the bore 126 of the insulator 120. In the exemplary embodiment shown in FIG. 4, the center electrode 140 includes a skirt 141 and a body 142. In illustrative embodiments, the skirt 141 of the center electrode 140 may be positioned in the first-bore section 127 and the stepped-bore section 126a. The skirt 141 is offset from the second longitudinal axis B (and not symmetrical about the second longitudinal axis B) and may generally be aligned with the first longitudinal axis A, as illustrated in FIG. 4. The body 142 of the center electrode 140 extends through the second-bore section 128 of the bore 126. A head section 143 of the body 142 extends axially beyond the second end 122 of the insulator 120 through the second opening 122a.

The ground electrode 150 extends along a portion of the outer periphery of the insulator 120. In the exemplary embodiment shown in FIG. 4, the ground electrode 150 extends from the second end 116 of the outer shell 110 to a position beyond the second end 122 of the insulator 120. The ground electrode 150 includes a first segment 151, a second segment 152, and a third segment 153.

The first segment 151 extends generally along a portion of the length of the insulator 120. In contrast to the exemplary embodiment of FIGS. 1-3, here, no portion of the first segment 151 is positioned between the outer shell 110 and the insulator 120. Rather, the first segment 151 of the ground electrode 150 is positioned beyond the second end 116 of the outer shell 110, along the outer periphery of the third section 125 of the insulator 120. The second segment 152 is positioned at an end of the first segment 151 opposite from where the first segment 151 is coupled to the outer shell 110. The second segment 152 may be a curved portion of the ground electrode 150.

The third segment 153 is positioned at one end of the second segment 152 that is opposite of where the second segment 152 is connected to the first segment 151. The third segment 153 may extend in a direction generally perpendicular to at least a portion of the first segment 151. The third segment 153 extends across the first and second longitudinal axes A and B. The third segment 153 is spaced from the head section 143 of the center electrode 40, thereby providing a spark gap G between the third segment 153 of the ground electrode 150 and the center electrode 140.

The resistor 160 is positioned in the bore 26 of the insulator 120 between the terminal stud 130 and center electrode 140 and provides an electrical communication between the terminal stud 130 and the center electrode 140. In exemplary embodiments, a first contact glass 161 and a second contact glass 162 are disposed adjacent to respective ends of the resistor 160. In illustrative embodiments, the first contact glass 161 may be disposed between the terminal stud 130 and the resistor 160. The second contact glass 162 may be disposed between the resistor 160 and the second contact glass 162.

FIGS. 1-3 and 4-6 illustrate a spark plug 5/100 constructed in accordance with an exemplary embodiment of the present invention. In illustrative embodiments, the spark plug 5/100 may be a small diameter spark plug. A “small diameter” spark plug refers generally to a spark plug having a reduced diameter in a lower region, between the spark gap G and the threaded region 17/117 of the spark plug 5/100, compared to conventional spark plugs. For example, a small diameter spark plug may have a diameter in the range of 7.5 mm-10 mm in the lower region of the spark plug. It is understood however, that in the exemplary embodiments, the diameter of the spark plug in this region is not limited to such range, and other diameters may be suitable depending on cost and manufacturing considerations. For example, a small diameter spark plug according to the exemplary embodiments described herein may have a diameter of less than 7.5 mm where costs and material handling considerations allow. In the exemplary embodiments below, this diameter is shown generally as D1 and D2 in figures.

In the exemplary embodiments detailed above and shown in the figures, by offsetting the second-bore section 28/128 from the first-bore section 27/127 and the first longitudinal axis A, and by including a threaded region 17/117 on the outer shell 10/110 in a central region of the spark plug 5/110 and a ground electrode 50/150 coupled to the outer shell 10/110, the insulator 20/120 wall thickness may be maintained or increased, especially near the ground electrode 50/150. As a result of maintaining or increasing the wall thickness, the dielectric strength may be maintained or increased as well. Accordingly, the spark plug 5/110 described herein may be used in standard ignition systems.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode for carrying out this invention, but that the invention will include all embodiments falling within the scope of the present application.

What is claimed is:

1. A spark plug comprising:
an outer shell defining a first longitudinal axis;
an insulator comprising a first opening at a first end thereof and a second opening at a second end thereof, at least a portion of the insulator extending within the outer shell;
an insulator bore extending between the first opening and the second opening of the insulator, the insulator bore comprising a first bore section extending along the first longitudinal axis, a second bore section extending along a second longitudinal axis, the second longitudinal axis offset from the first longitudinal axis, and a stepped bore section positioned between the first bore section and the second bore section;
a terminal stud at least partially disposed in the first bore section;
a center electrode positioned at least partially in the second bore section; and
a ground electrode extending with the insulator and terminating at a position axially beyond the second end of the insulator.

2. The spark plug of claim 1, wherein the outer shell comprises a threaded region form on an outer periphery thereof.

3. The spark plug of claim 1, wherein the terminal stud comprises:
a head extending out of the first opening at the first end of the insulator; and a body extending through the first bore section of the insulator bore.

4. The spark plug of claim 3, where the center electrode comprises:
a skirt positioned at least partially in the stepped bore section of the insulator;
a body portion extending in the second bore section, the body portion; and a head portion extending axially beyond the second end of the insulator through a the second opening of the insulator.

5. The spark plug of claim 1, wherein the outer shell includes a first diameter section and an outer shell stepped diameter section.

6. The spark plug of claim 5, wherein the outer shell further comprises a second diameter section, the outer shell stepped diameter section positioned between the first diameter section and the second diameter section in a direction along the first longitudinal axis.

7. The spark plug of claim 6, wherein the first diameter section has a first diameter and the second diameter section has a second diameter, the second diameter being less than the first diameter.

8. The spark plug of claim 1, further comprising a resistor positioned in the insulator bore between the terminal stud and the center electrode.

9. The spark plug of claim 5, wherein the ground electrode includes a first segment extending along a length of the spark plug, a second segment that is curved, and a third segment extending in a direction generally perpendicular to the first longitudinal axis and the second longitudinal axis.

10. The spark plug of claim 9, wherein the third segment of the ground electrode is spaced from a body of the center electrode in a direction along the second longitudinal axis.

11. An insulator for a spark plug, the insulator comprising:
a first end having a first opening;
a second end having a second opening;
a bore extending from the first opening to the second opening, the bore comprising:
a first section symmetrical about a first longitudinal axis and configured to receive a terminal stud; and
a second section symmetrical about a second longitudinal axis and configured to receive a center electrode, the second longitudinal axis being offset from the first longitudinal axis.

12. The insulator of claim 11, wherein the bore further comprises a stepped section between the first section and the second section.

13. A spark plug comprising:
an outer shell;
an insulator having a bore extending therethrough, the bore having a first bore section and a second bore section, the first bore section and the outer shell extending along a common longitudinal axis, the second bore section extending along a second longitudinal axis that is offset from the common longitudinal axis;
a center electrode; and
a ground electrode.

14. The spark plug of claim 13, wherein the center electrode includes a head extending out of the bore and axially beyond a first end of the insulator.

15. The spark plug of claim 14, wherein the ground electrode includes a first segment extending along a portion of the length of the spark plug, a second segment curved relative to the first segment, and a third segment extending in a direction perpendicular to at least a portion of the first segment.

16. The spark plug of claim 15, wherein the third segment extends across the common longitudinal axis and second longitudinal axis and is spaced from the head of the center electrode by a spark gap.

17. The spark plug of claim 16, wherein at least a portion of the insulator is positioned radially within the outer shell and an opening is formed between the outer shell and the insulator, at least a portion of the ground electrode being received in the opening.

18. The spark plug of claim 16, wherein the ground electrode extends from a second end of the outer shell along an outer periphery of the insulator.

19. The spark plug of claim 13, wherein the outer shell further comprises a threaded region on its outer periphery.

20. The spark plug of claim 13 further comprising a resistor positioned between the terminal stud and the center electrode.
